(19) United States
(12) Patent Application Publication
(10) Pub. No.: US 2009/0161756 A1
(43) Pub. Date: Jun. 25, 2009

(54) Method and apparatus for motion adaptive pre-filtering

(75) Inventor: Peng Lin, Pleasanton, CA (US)

Correspondence Address: DICKSTEIN SHAPIRO LLP, 1825 EYE STREET NW, Washington, DC, 20006-5403, US

(73) Assignee: MICRON TECHNOLOGY, INC.

(21) Appl. No.: 12/003,047

(22) Filed: Dec. 19, 2007

(51) Int. Cl. H04N 11/02; H04N 5/335

(52) U.S. Cl. 375/240.02; 375/240.16; 348/294; 375/E07.076; 348/E05.091

(57) ABSTRACT

A video filter includes a motion detector to detect motion between frames of a video for each pixel, a shape adaptive spatial filter and a weighted temporal filter. The spatial filter and the temporal filter are smoothly mixed together based on the amount of motion detected by the motion detector for each pixel. When the motion detected by the motion detector is low, the video filter tends to do more temporal filtering. When the motion detected by the motion detector is high, the video filter tends to do more spatial filtering.

### FIELD OF THE INVENTION

Embodiments relate to noise removal in digital cameras, and more specifically to noise pre-filtering in digital cameras.

### BACKGROUND OF THE INVENTION

Video signals are often corrupted by noise during the video signal acquisition process. Noise levels are especially high when video is acquired during low-light conditions. The effect of the noise not only degrades the visual quality of the acquired video signal, but also renders compression of the video signal more difficult. Random noise does not compress well. Consequently, random noise requires substantial bit rate overhead if it is to be compressed.

One method to reduce the effects of random noise is to use a pre-filter 10, as illustrated in FIG. 1. A pre-filter 10 receives a video signal from an imaging sensor 5 and filters the video signal before the signal is encoded by an encoder 15. The pre-filter 10 removes noise from the video signal, enhances the video quality, and renders the video signal easier to compress. However, poorly designed pre-filters tend to introduce additional degradations to the video signal while attempting to remove noise. For example, using a low-pass filter as a pre-filter or compression removes significant edge features and reduces the contrast of the compressed video.

Additionally, designing a proper video pre-filter requires considering both spatial and temporal characteristics of the video signal. In non-motion areas of received video content, applying a temporal filter is preferred while in areas with motion, applying a spatial filter is more appropriate. Using a temporal filter in a motion area causes motion blur. Using a spatial filter in a non-motion area lessens the noise reduction effect. Designing a pre-filter that has both spatial and temporal filtering capabilities and can dynamically adjust its spatial-temporal filtering characteristics to the received video content is desired.

### BRIEF DESCRIPTION OF THE DRAWINGS

FIG. 1 is a simplified block diagram of an imaging system.

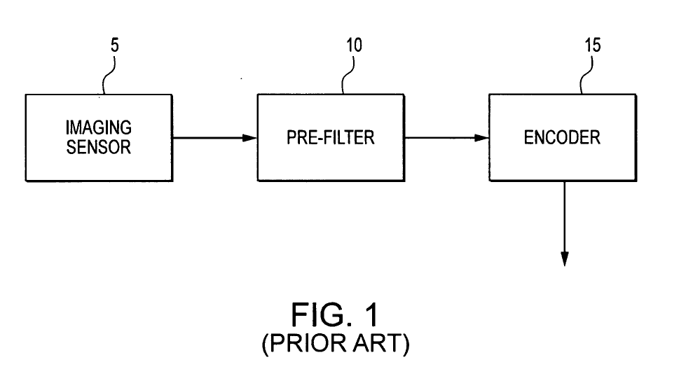

FIG. 2 is a block diagram of a motion adaptive pre-filter according to a disclosed embodiment.

FIG. 3 is a graphical illustration of a block motion indicator function according to a disclosed embodiment.

FIG. 4 is a diagram of pixels used to calculate a predicted pixel motion indicator according to a disclosed embodiment.

FIG. 5 is a block diagram of an imager system according to a disclosed embodiment.

FIG. 6 is a block diagram of a processing system according to a disclosed embodiment.

### DETAILED DESCRIPTION OF THE INVENTION

The disclosed video signal pre-filter is a motion adaptive pre-filter suitable for filtering video signals prior to video compression. The motion adaptive pre-filter includes a shape adaptive spatial filter, a weighted temporal filter and a motion detector for detecting motion. Based on the motion information collected by the motion detector, the motion adaptive pre-filter adaptively adjusts its spatial-temporal filtering characteristics. When little or no motion is detected, the pre-filter is tuned to more heavily apply temporal filtering for maximal noise reduction. On the other hand, when motion is detected, the pre-filter is tuned to more heavily apply spatial filtering in order to avoid motion blur. Additionally, the spatial filter is able to adjust its shape to match the contours of local image features, thus preserving the sharpness of the image.

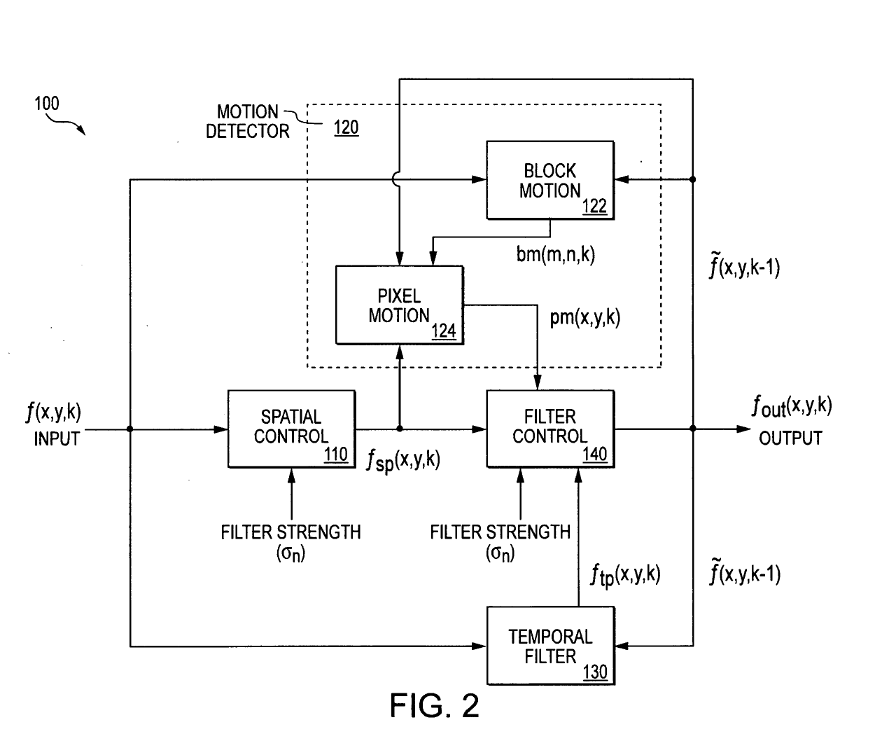

FIG. 2 illustrates a block diagram of the motion adaptive pre-filter 100. The pre-filter 100 receives as input a signal representing a current video frame f(x,y,k). Additionally, the pre-filter 100 receives a filter strength variable σₙ that is correlated to the noise level (i.e., the noise variance) of the current video frame f(x,y,k). The pre-filter 100 outputs a filtered video frame fₒᵤₜ(x,y,k), which is fed back into the pre-filter 100 as a previously filtered frame \tilde{f}(x,y,k−1) during the processing of a successive current video frame f(x,y,k).

The main components of the motion adaptive pre-filter 100 include a spatial filter 110, a motion detector 120 and a weighted temporal filter 130. The motion detector 120 includes a block motion unit 122 and a pixel motion unit 124. The outputs of the spatial filter 110 (i.e., fₛₚ(x,y,k)), the temporal filter 130 (i.e., fₜₚ(x,y,k)) and the motion detector 120 (i.e., pm(x,y,k)) are combined by the filter control 140 to produce the filtered current frame output fₒᵤₜ(x,y,k). Among these components, the performance of the motion adaptive pre-filter 100 is largely determined by the accuracy of the motion detector 120.

The filtered current frame output fₒᵤₜ(x,y,k) is the result of the filter control 140, which properly combines the spatially filtered current frame signal fₛₚ(x,y,k), the temporally filtered current frame signal fₜₚ(x,y,k) and the motion indicator pm(x,y,k) according to the following equation:

fₒᵤₜ(x,y,k)=(1−pm(x,y,k))·fₜₚ(x,y,k)+pm(x,y,k)·f(x,y,k). Equation 1.

In equation 1, the motion indicator pm(x, y, k) has a value ranging from 0 to 1, with a 0 representing no motion and a 1 representing motion. Thus, when the motion detector 120 detects no motion, the temporal filter 130 dominates the pre-filter 100. When the motion detector 120 detects maximal motion, the spatial filter 110 dominates.

The operations of each of the components of the pre-filter 100 are described below.

The spatial filter 110 includes spatial filters for the Y, U and V components of an image using the YUV color model. In the YUV color model, the Y component represents the brightness of the image. The U and V components represent the color of the image. The shape adaptive spatial filter applied in the spatial filter 110 to the Y component of the image is a variation of a conventional adaptive spatial filter pioneered by D. T. Kuan. The Kuan filter is a minimum mean square error (“MMSE”) filter. The Kuan MMSE filter performs spatial adaptive filtering based on local image characteristics and is thus able to avoid excessive blurring in the vicinity of edges and other image details, though at some cost, as explained below.

The Kuan MMSE filter is expressed below in equation 2:

$$g ( x , y ) = {μ}_{f} ( x , y ) + \frac{max ( {σ}_{f}^{2} - {σ}_{n}^{2} , 0 )}{max ( {σ}_{f}^{2} - {σ}_{n}^{2} , 0 ) + {σ}_{n}^{2}} [ f ( x , y ) - {μ}_{f} ( x , y ) ] .. \qquad Equation 2$$

In equation 2, f(x,y) is the input image, g(x,y) is the filtered image, σₙ² is the noise variance, and μ_{f}(x,y) and σ_{f}²(x,y) are the local mean and variance of the input image, computed respectively in equations 3 and 4 below:

$$\begin{matrix}{μ}_{f} ( x , y ) = {\sum }_{{x}_{i} , {y}_{i} ∈ W} f ( {x}_{i} , {y}_{i} ) / \vert W \vert .. & Equation 3 \\ {σ}_{f}^{2} ( x , y ) = {\sum }_{{x}_{i} , {y}_{i} ∈ W} {[ f ( {x}_{i} , {y}_{i} ) - {μ}_{f} ( x , y ) ]}^{2} / \vert W \vert .. & Equation 4\end{matrix}$$

In equations 3 and 4, W represents a window centered at pixel (x,y), and |W| denotes the window size.

From equation 2, it can be observed that when the variance σ_{f}²(x,y) is small (e.g., in a non-edge area), the filtered image g(x,y) approaches the local mean μ_{f}(x,y) of the input image. In other words, in non-edge areas, the dominant component of the Kuan MMSE filter becomes the mean μ_{f}(x,y), meaning that maximal noise reduction is performed in non-edge areas. Conversely, in edge areas, or where the variance σ_{f}²(x,y) is large, the filter is basically switched off as the dominant component of the Kuan MMSE filter becomes the input image f(x,y). Thus, in edge areas, the Kuan MMSE filter reduces the amount of noise reduction in order to avoid blur. The result is that by turning off the filter at an edge area, the Kuan MMSE filter is able to preserve edges, but noise in and near the edge area is not removed.

To overcome this drawback of the Kuan MMSE filter, the Kuan MMSE filter of equation 2 is modified as follows in equation 5:

$${f}_{sp}^{Y} ( x , y ) = {μ}_{Y} ( x , y ) + \frac{A \cdot max ( {σ}_{Y}^{2} - {σ}_{n}^{2} , 0 )}{A \cdot max ( {σ}_{Y}^{2} - {σ}_{n}^{2} , 0 ) + {σ}_{n}^{2}} [ {f}_{s}^{Y} ( x , y ) - {μ}_{Y} ( x , y ) ] .. \qquad Equation 5$$

In equation 5, fₛₚ^{Y}(x,y) is the Y component of the spatially filtered image, A is a parameter (preferably, A=4), and fₛ^{Y}(x,y) is a shape adaptive filter applied to the Y-component of the image. In non-edge areas where the Y-component of the variance σ_{Y}²(x,y) is small, the Y component of the filtered image fₛₚ^{Y}(x,y) approaches the Y component of the local mean μ_{Y}(x,y) of the input image. However, near edges, where the Y component variance σ_{Y}²(x,y) is high, the Y component of the filtered image fₛₚ^{Y}(x,y) approaches the value of the shape adaptive filter fₛ^{Y}(x,y). The shape adaptive filter fₛ^{Y}(x,y) is defined below in equation 6:

$${f}_{s}^{Y} ( x , y ) = \frac{{\sum }_{{x}_{i} , {y}_{i} ∈ W} ϖ ( {x}_{i} , {y}_{i} ) \cdot {f}^{Y} ( {x}_{i} , {y}_{i} )}{{\sum }_{{x}_{i} , {y}_{i} ∈ W} ϖ ( {x}_{i} , {y}_{i} )} , . \qquad Equation 6$$

where W is a window centered at pixel (x,y). Essentially, the shape adaptive filter fₛ^{Y}(x,y) is a weighted local mean, with the weighting function ω̅(xᵢ,yᵢ) being defined in equation 7 as:

$$ϖ ( {x}_{i} , {y}_{i} ) = \{ \begin{matrix} {w}_{1} , & if \vert {f}^{Y} ( {x}_{i} , {y}_{i} ) - {f}^{Y} ( x , y ) \vert < {c}_{1} {σ}_{n} \\ {w}_{2} , & if {c}_{1} {σ}_{n} \leq \vert {f}^{Y} ( {x}_{i} , {y}_{i} ) - {f}^{Y} ( x , y ) \vert < {c}_{2} {σ}_{n} \\ {w}_{3} , & if {c}_{2} {σ}_{n} \leq \vert {f}^{Y} ( {x}_{i} , {y}_{i} ) - {f}^{Y} ( x , y ) \vert < {c}_{3} {σ}_{n} \\ 0 , & otherwise , .\end{matrix} \qquad Equation 7$$

where σₙ² is the noise variance and w₁, w₂, w₃, c₁, c₂ and c₃ are parameters. In one desired implementation, w₁=3, w₂=2, w₃=1, c₁=1, c₂=2, and c₃=4 are used, and W is chosen to be a 3×3 window. Thus, in areas near edges, noise reduction is performed according to a weighted scale. In other words, the shape adaptive filter defined in equation 6 is able to adapt its shape to the shape of an edge in a window W in order to avoid blurring. Instead of simply switching off the filter as the adaptive MMES filter of equation 2 does near an edge area, the adaptive spatial filter of equation 5 uses a shape adaptive filter to remove noise while preserving edges.

The adaptive spatial filter is adaptive around areas of high image variance (e.g., edges), and hence is appropriate to use for filtering the Y component of an image f(x,y). Although equation 5 may also be used to filter the U and V color components of the image f(x,y), a simplified filter is used instead when filtering U and V components. The adaptive spatial filter for filtering the U component is defined in equation 8 as follows:

fₛₚ^{U}(x,y)=(1−β(x,y))·μ_{U}(x,y)+β(x,y)·f^{U}(x,y), Equation 8.

where, as defined in equation 9 below, the function β(x,y) is:

$$β ( x , y ) = \frac{min ( {T}_{2} - {T}_{1} , max ( {σ}_{U}^{2} - {T}_{1} , 0 ) )}{{T}_{2} - {T}_{1}} , . \qquad Equation 9$$

and where μ_{U}(x,y) is the local mean of the U component, σ_{U}²(x,y) is the local variance of the U component, and f^{U}(x,y) is the U component of the input image. The variables T₁ and T₂ are defined as T₁=(a₁σₙ)² and T₂=(a₂σₙ)². The noise variance is represented by σₙ². In one implementation, a₁=1 and a₂=3. Thus, in areas of the U component of the input image f^{U}(x,y) that have low variance (i.e., the local U variance σ_{U}²(x,y) is less than T₁), the adaptive spatial U filter fₛₚ^{U}(x,y) approaches the value of μ_{U}(x,y) (maximum filtering). In areas of the U component of the input image f^{U}(x,y) that have high variance (i.e., the local U variance σ_{U}²(x,y) is greater than T₂), the adaptive spatial U filter fₛₚ^{U}(x,y) approaches the value of f^{U}(x,y) (no filtering). For values of the U component of the input image f^{U}(x,y) with a variance in between the T₁ and T₂ values, the amount of filtering (i.e., the strength of the μ_{U}(x,y) component of equation 8) varies linearly.

The spatial filter for the V component is defined similarly to that of the U component (in equations 8 and 9). Using equations 5 and 8, the spatially filtered Y, U and V components of the image f(x,y) may be determined while still removing noise from high-variance areas (e.g., edge areas) but avoiding edge-blurring.

The temporal filter 130 used in the motion adaptive pre-filter 100 is a recursive weighted temporal filter and is defined as follows:

fₜₚ(x,y,k)=w·f(x,y,k)+(1−w)·\tilde{f}(x,y,k−1) Equation 10.

where f(x,y,k) is the current frame, \tilde{f}(x,y,k−1) is the filtered previous frame, and w and 1−w are filter weights. In an implementation, w=⅓. In this implementation, the temporal filter output fₜₚ(x,y,k) is a weighted combination of the current frame f(x,y,k) and the filtered previous frame \tilde{f}(x,y,k−1), with more emphasis being placed on the filtered previous frame \tilde{f}(x,y,k−1). The temporal filter of equation 10 is applied to each of the Y, U and V components of an image.

The motion detector 120 is a key component in the motion adaptive pre-filter 100. Accurate motion detection results in effective use of the above-described spatial and temporal filters. Inaccurate motion detection, however, can cause either motion blur or insufficient noise reduction. Motion detection becomes even tougher when noise is present.

The motion detection technique used in the motion detector 120 of the pre-filter 100 includes both block motion detection 122 and pixel motion detection 124, though ultimately pixel motion detection 124 is applied to the outputs of the temporal filter 130 and the spatial filter 110. Block motion, however, is useful in determining object motion and, hence, pixel motion.

As illustrated in FIG. 2, block motion detection 122 utilizes the current frame f(x,y,k) and the filtered previous frame \tilde{f}(x,y,k−1). To detect block motion, the frame is divided into blocks. In one implementation, the frame is divided into blocks that each include 64 pixels (using an 8×8 grid). For each block, a block motion indicator bm(m,n,k) is determined. The value of each block motion indicator bm(m,n,k) ranges from 0 to 1. A block motion indicator value of 0 means no motion; a block motion indicator value of 1 means maximal motion. As implemented, the block motion indicator for every block is quantized into 3-bit integer values and stored in a buffer.

In a first step of block motion detection 122 for a block B(m,n), the mean absolute difference (“mad”) for the block is computed as follows in equation 11:

$${mad}_{B} ( m , n , k ) = {\sum }_{i , j ∈ B ( m , n )} \vert f ( i , j , k ) - \tilde{f} ( i , j , k - 1 ) \vert / 64. . \qquad Equation 11$$

The absolute difference used in equation 11 is the difference between the value of each pixel in the current frame and the filtered previous frame. If motion has occurred, there will be differences in the pixel values from frame to frame. These differences (or lack of differences in the event that no motion occurs) are used to determine an initial block motion indicator bm₀(m,n,k), as illustrated in equation 12, which follows:

$${bm}_{0} ( m , n , k ) = \frac{min ( {t}_{2} - {t}_{1} , max ( {mad}_{B} ( m , n , k ) - {t}_{1} , 0 ) )}{{t}_{2} - {t}_{1}} .. \qquad Equation 12$$

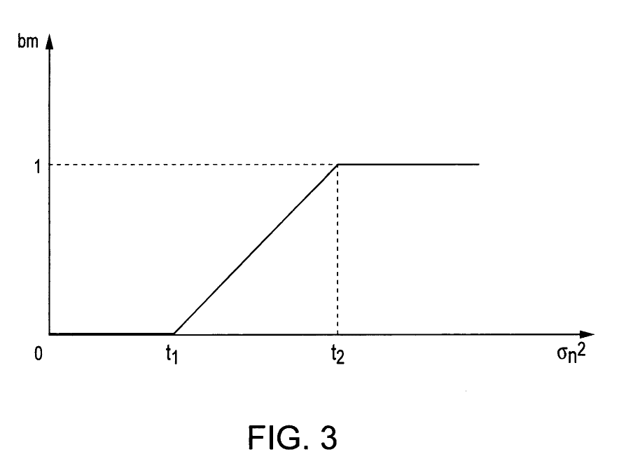

In equation 12, the variables t₁ and t₂ are defined as t₁=(α₁σₙ)² and t₂=(α₂σₙ)². As in the previously discussed equations, the noise variance is represented by σₙ². In one implementation, α₁=1 and α₂=3. FIG. 3 illustrates a graph of the initial block motion detection function of equation 12. As FIG. 3 illustrates, and as can be determined using equation 11, if a block B(m,n) has little or no motion (i.e., if mad_{B}(m,n,k) is less than or equal to t₁), then the initial block motion indicator bm₀(m,n,k) will have a value equal to zero. If the block B(m,n) has a great amount of motion (i.e., if mad_{B}(m,n,k) is greater than or equal to t₂), then the initial block motion indicator bm₀(m,n,k) will have a value equal to one. Initial block motion indicator bm₀(m,n,k) values in between zero and one are determined when mad_{B}(m,n,k) is greater than t₁ and less then t₂.

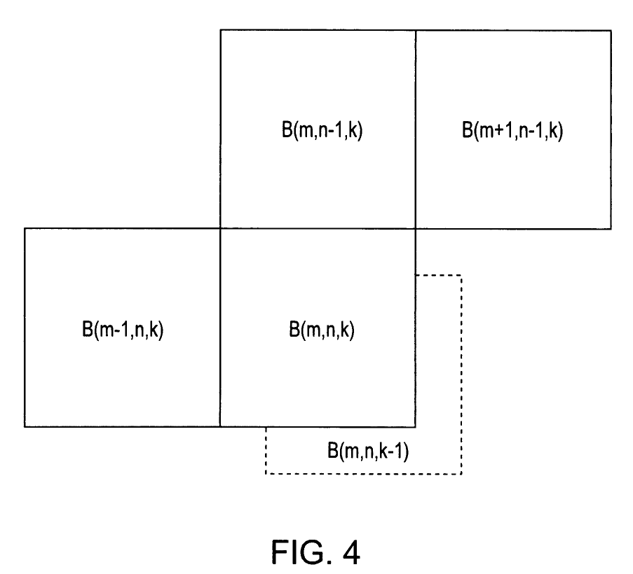

In a second step of block motion detection for block B(m,n), a determination is made regarding whether block motion for block B(m,n) is expected based on the block motion of the same block at a previous frame or neighboring blocks. The basic idea is that if neighboring blocks have motion, then there is a high possibility that the current block also has motion. Additionally, if the collocated block in the previous frame has motion, there is a higher chance that the current block has motion as well. FIG. 4 illustrates the blocks used to predict whether block B(m,n) is expected to have block motion. The predicted block motion indicator is calculated according to equation 13 below:

bm_{—}pred(m,n,k)=max(bm(m,n,k−1),bm(m,n−1,k),bm(m+1,n−1,k),bm(m−1,n,k)). Equation 13.

A block motion indicator for a block B(m,n) is determined by using the initial block motion indicator bm₀(m,n,k) and the predicted block motion indicator bm_pred(m,n,k) as in equation 14:

$$bm ( m , n , k ) = \{ \begin{matrix} {bm}_{0} ( m , n , k ) , & \text{if} {bm}_{0} ( m , n , k ) > bm\_pred ( m , n , k ) \\ ( {bm}_{0} ( m , n , k ) + bm\_pred ( m , n , k ) ) / 2 , & \text{otherwise} ..\end{matrix} \qquad Equation 14$$

Block motion detection 122 is performed using only the Y component of the current frame f(x,y,k), and is performed according to equation 14. Once a block motion indicator bm(m,n,k) has been calculated, the pixel motion indicators pm(x,y,k) for each pixel in the block B(m,n) may be determined during pixel motion detection 124. Pixel motion is computed for each of the Y, U and V components of the current frame f(x,y,k).

The pixel motion indicator for the Y component is determined with reference to the spatially filtered current frame fₛₚ(x,y,k), the filtered previous frame \tilde{f}(x,y,k−1), and the block motion indicator bm(m,n,k) for the block in which the pixel is located. First, an initial pixel motion indicator pm₀(x,y,k) is calculated according to equation 15, as follows:

$${pm}_{0} ( x , y , k ) = \frac{min ( {s}_{2} - {s}_{1} , max ( diff - {s}_{1} , 0 ) )}{{s}_{2} - {s}_{1}} .. \qquad Equation 15$$

In equation 15, the variables s₁ and s₂ are defined as s₁=β₁σₙ and s₂=β₁σₙ, while σₙ² is define as the noise variance. In an implementation, β₁=1 and β₂=2. The function diff is calculated according to equation 16:

diff=|fₛₚ(x,y,k)−\tilde{f}(x,y,k−1)|. Equation 16.

In equation 16, fₛₚ(x,y,k) is the output of the spatial filter and \tilde{f}(x,y,k−1) is the filtered previous frame. The calculation of the initial pixel motion indicator pm₀(x,y,k) is similar to the calculation of the initial block motion indicator bm₀(m,n,k). At the pixel level, the absolute difference between the spatially filtered pixel value fₛₚ(x,y,k) and the filtered previous pixel value \tilde{f}(x,y,k−1) is determined and then used to determine a value between 0 and 1 for the initial pixel motion indicator pm₀(x,y,k). Using the calculated initial pixel motion pm₀(x,y,k) and the block motion indicator bm(m,n,k), the Y component of the pixel motion can be obtained as follows:

pm(x,y,k)=(1−pm₀(x,y,k))·bm(m,n,k)+pm₀(x,y,k), Equation 17.

where bm(m,n,k) is the block motion for the block that contains the pixel (x,y).

For the U and V components, a simpler formula for calculating the pixel motion indicator may be used. The pixel motion indicator pm^{U}(x,y,k) can be computed according to equation 18, as follows:

$${pm}^{U} ( x , y , k ) = \{ \begin{matrix} pm ( x , y , k ) , & if {diff}^{U} < {t}_{c} \\ 1 , & otherwise , .\end{matrix} \qquad Equation 18$$

where diff^{U} is computed using equation 19 below:

diff^{U}=|fₛₚ^{U}(x,y,k)−\tilde{f}^{U}(x,y,k−1)|. Equation 19.

In Equation 18, the value t_{c} is defined as t_{c}=γσₙ. In an implementation, γ=2.

The pixel motion for the V component may be computed similarly.

With the above-defined spatial filter fₛₚ(x,y,k) and weighted temporal filter fₜₚ(x,y,k), and the computed pixel motion pm(x,y,k), the motion adaptive pre-filter 100 can be expressed as:

fₒᵤₜ(x,y,k)=(1−pm(x,y,k))·fₜₚ(x,y,k)+pm(x,y,k)·fₛₚ(x,y,k). Equation 20.

In practice, the output fₒᵤₜ(x,y,k) is calculated for each of the three image components, Y, U and V. Thus, equation 20 represents the combination of the following equations 21, 22 and 23.

fₒᵤₜ^{Y}(x,y,k)=(1−pm^{Y}(x,y,k))·fₜₚ^{Y}(x,y,k)+pm^{Y}(x,y,k)·fₛₚ^{Y}(x,y,k). Equation 21.

fₒᵤₜ^{U}(x,y,k)=(1−pm^{U}(x,y,k))·fₜₚ^{U}(x,y,k)+pm^{U}(x,y,k)·fₛₚ^{U}(x,y,k). Equation 22.

fₒᵤₜ^{V}(x,y,k)=(1−pm^{V}(x,y,k))·fₜₚ^{V}(x,y,k)+pm^{V}(x,y,k)·fₛₚ^{V}(x,y,k). Equation 23.

The main parameter of the motion adaptive pre-filter is the filter strength or noise level σₙ. When implementing the pre-filtering method in a video capture system, σₙ can be set to depend on the imaging sensor characteristics and the exposure time. For example, through experiment or calibration, the noise level σₙ associated with a specific imaging sensor may be identified. Similarly, for a given sensor, specific noise levels σₙ may be associated with specific exposure times. A relationship between identified imaging sensor characteristics and exposure time may be used to set the filter strength or noise level σₙ prior to using the motion adaptive pre-filter 100.

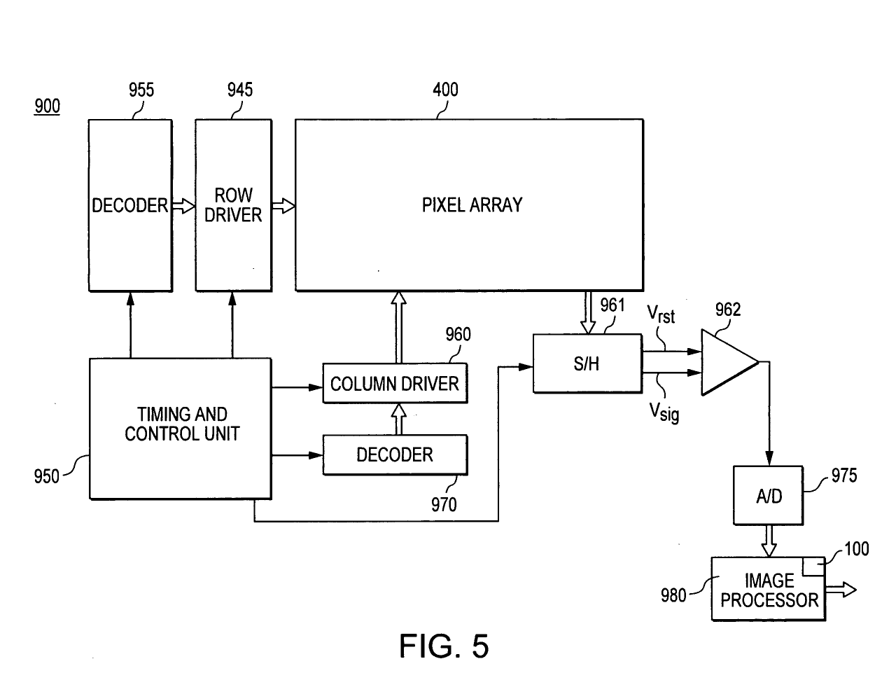

The motion adaptive pre-filter 100, as described above, may be implemented using either hardware or software or via a combination of hardware and software. For example, in a semiconductor CMOS imager 900, as illustrated in FIG. 5, the pre-filter 100 may be implemented within an image processor 980. FIG. 5 illustrates a simplified block diagram of a semiconductor CMOS imager 900 having a pixel array 400 including a plurality of pixel cells arranged in a predetermined number of columns and rows. Each pixel cell is configured to receive incident photons and to convert the incident photons into electrical signals. Pixel cells of pixel array 940 are output row-by-row as activated by a row driver 945 in response to a row address decoder 955. Column driver 960 and column address decoder 970 are also used to selectively activate individual pixel columns. A timing and control circuit 950 controls address decoders 955, 970 for selecting the appropriate row and column lines for pixel readout. The control circuit 950 also controls the row and column driver circuitry 945, 960 such that driving voltages may be applied. Each pixel cell generally outputs both a pixel reset signal vᵣₛₜ and a pixel image signal v_{sig}, which are read by a sample and hold circuit 961 according to a correlated double sampling (“CDS”) scheme. The pixel reset signal vᵣₛₜ represents a reset state of a pixel cell. The pixel image signal v_{sig} represents the amount of charge generated by the photosensor in the pixel cell in response to applied light during an integration period. The pixel reset and image signals vᵣₛₜ, v_{sig} are sampled, held and amplified by the sample and hold circuit 961. The sample and hold circuit 961 outputs amplified pixel reset and image signals vᵣₛₜ, v_{sig}. The difference between V_{sig} and Vᵣₛₜ represents the actual pixel cell output with common-mode noise eliminated. The differential signal (e.g., Vᵣₛₜ−V_{sig}) is produced by differential amplifier 962 for each readout pixel cell. The differential signals are digitized by an analog-to-digital converter 975. The analog-to-digital converter 975 supplies the digitized pixel signals to an image processor 980, which forms and outputs a digital image from the pixel values. The output digital image is the filtered image resulting from the pre-filter 100 of the image processor 980. Of course, the pre-filter 100 may also be separate from the image processor 980, pre-filtering image data before arrival at the image processor 980.

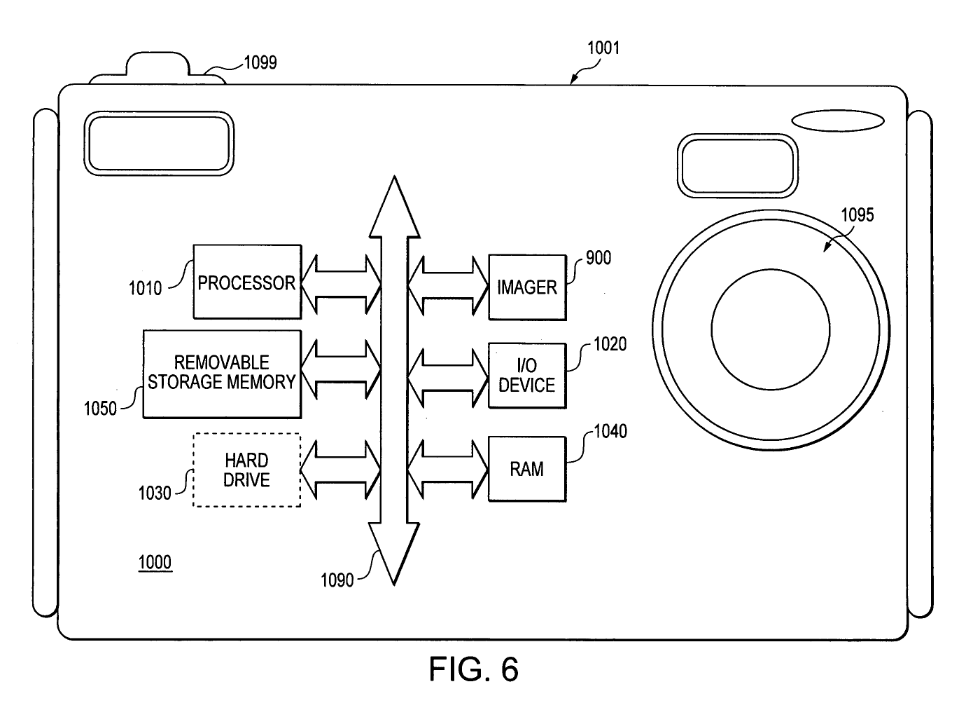

The pre-filter 100 may be used in any system which employs a moving image or video imager device, including, but not limited to a computer system, camera system, scanner, machine vision, vehicle navigation, video phone, surveillance system, auto focus system, star tracker system, motion detection system, image stabilization system, and other imaging systems. Example digital camera systems in which the invention may be used include video digital cameras, still cameras with video options, cell-phone cameras, handheld personal digital assistant (PDA) cameras, and other types of cameras. FIG. 6 shows a typical system 1000 which is part of a digital camera 1001. The system 1000 includes an imaging device 900 which includes either software or hardware to implement the pre-filter 100 in accordance with the embodiments described above. System 1000 generally comprises a processing unit 1010, such as a microprocessor, that controls system functions and which communicates with an input/output (I/O) device 1020 over a bus 1090. Imaging device 900 also communicates with the processing unit 1010 over the bus 1090. The system 1000 also includes random access memory (RAM) 1040, and can include removable storage memory 1050, such as flash memory, which also communicates with the processing unit 1010 over the bus 1090. Lens 1095 focuses an image on a pixel array of the imaging device 900 when shutter release button 1099 is pressed.

The system 1000 could alternatively be part of a larger processing system, such as a computer. Through the bus 1090, the system 1000 illustratively communicates with other computer components, including but not limited to, a hard drive 1030 and one or more removable storage memory 1050. The imaging device 900 may be combined with a processor, such as a central processing unit, digital signal processor, or microprocessor, with or without memory storage on a single integrated circuit or on a different chip than the processor.

It should be noted that although the embodiments have been described with specific reference to CMOS imaging devices, they have broader applicability and may be used in any imaging apparatus which generates pixel output values, including charge-coupled devices CCDs and other imaging devices.

What is claimed as new and desired to be protected by Letters Patent of the United States is:

1. An image filter, comprising:
a motion detector to detect motion between frames of video;
a spatial filter to filter a current video frame
a temporal filter to average the current video frame with a previous video frame; and
a controller to combine outputs of the spatial filter and the temporal filter for each pixel of the current video frame in response to the motion detected by the motion detector.

2. The video filter of claim 1, wherein the spatial filter outputs a local mean of the current video frame for image regions that do not include an object edge.

3. The video filter of claim 1, wherein the spatial filter outputs a local mean of the current video frame for frame regions with a local variance that is smaller than a predefined threshold.

4. The video filter of claim 3, wherein the predefined threshold is a noise variance value.

5. The video filter of claim 4, wherein the noise variance value is determined with reference to exposure time and characteristics of an imager used to capture the video.

6. The video filter of claim 1, wherein the spatial filter output is dominated by a shape adaptive filter output for frame regions that include an object edge.

7. The video filter of claim 6, wherein the shape adaptive filter is a weighted local mean function.

8. The video filter of claim 1, wherein the temporal filter is a recursive weighted temporal filter.

9. The video filter of claim 1, wherein the motion detector includes a block motion detector and a pixel motion detector.

10. The video filter of claim 9, wherein the block motion detector determines an initial block motion indicator for a block of pixels in the current video frame based upon differences between current and previous pixel values for pixels within the block.

11. The video filter of claim 10, wherein the block motion detector determines a block motion indicator for a block by combining the block's initial block motion indicator with the block motion indicator of neighboring blocks and a collocated block in the previous video frame.

12. The video filter of claim 9, wherein the pixel motion detector determines a pixel motion indicator for a pixel by combining a block motion indicator for a block that includes the pixel with an initial pixel motion indicator that is based on a difference between the spatially filtered pixel's value in the current video frame and the pixel's value in a filtered previous video frame.

13. The video filter of claim 1, wherein the controller outputs a weighted average of the spatial filter output and the temporal filter output for each pixel of the current video frame with the weights being monotonic functions of the motion detected by the motion detector.

14. A spatial filter for an image, comprising:
a modified minimum mean square error filter; and
a shape adaptive filter that is a dominant component of the modified minimum mean square error filter when the shape adaptive spatial filter is applied to a region of the image that includes object edges.

15. The spatial filter of claim 14, wherein the shape adaptive filter is a weighted local mean function.

16. The spatial filter of claim 15, wherein the weights for the weighted local mean function are selected based upon differences between a value of a pixel being filtered and other pixels in the image.

17. An imager, comprising:
a pixel array that generates pixel values for a current image frame; and
a motion detector to detect motion between image frames;
a spatial filter to filter a current image frame
a temporal filter to average the current image frame with a previous image frame; and
a controller to combine outputs of the spatial filter and the temporal filter for each pixel of the current image frame in response to the motion detected by the motion detector.

18. The imager of claim 17, wherein the spatial filter outputs a local mean of the current image frame for image regions with a local variance that is smaller than a predefined noise variance value.

19. The imager of claim 18, wherein the noise variance value is determined with reference to exposure time and characteristics of an imager used.

20. The imager of claim 17, wherein the spatial filter is dominated by a shape adaptive filter for current image frame regions that include an object edge, the shape adaptive filter being a weighted local mean function.

21. The imager of claim 17, wherein the motion is detected using a block motion detector and a pixel motion detector.

22. The imager of claim 17, wherein the controller outputs a weighted average of the spatial filter output and the temporal filter output for each pixel of the current image frame with the weights being monotonic functions of the motion detected by the motion detector.

23. A method of filtering a video, comprising:
determining one or more motion indicators between video frames;
applying a spatial filter to filter the current video frame;
applying a temporal filter to average the current video frame with a previous video frame; and
applying a controller to combine outputs of the spatial filter and the temporal filter for each pixel of the current video frame in response to the one or more motion indicators.

24. The method of claim 23, wherein determining one or more motion indicators further comprises:
determining a plurality of block motion indicators for the video frames; and
using the block motion indicators to determine pixel motion indicators.

25. The method of claim 23, wherein applying a spatial filter further comprises outputting a local mean of the current video frame for frame regions that do not include an object edge.

26. The method of claim 23, wherein applying a spatial filter further comprises outputting a weighted local mean of the current video frame for frame regions that include an object edge.

27. The method of claim 23, wherein applying a temporal filter further comprises applying a recursive weighted temporal filter to the current video frame.

28. The method of claim 23, wherein applying the controller further comprises outputting a weighted average of the spatial filter output and the temporal filter output for each pixel of the current video frame with the weights being monotonic functions of the motion indicators.
